(19) United States
(12) Patent Application Publication
(10) Pub. No.: US 2007/0212447 A1
(43) Pub. Date: Sep. 13, 2007

(54) Food Ingredient Including Enriched Free Amino Acids and Their Production Method

(76) Inventors: Yoichi Nogata, Hiroshima (JP); Toshiroh Horino, Hiroshima (JP); Takashi Nagamine, Tochigi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/590,436

(22) PCT Filed: Feb. 27, 2004
(86) PCT No.: PCT/JP04/02353

§ 371 Date: Aug. 23, 2006

(51) Int. Cl. A21D 8/02; A21D 2/00

(52) U.S. Cl. 426/18; 426/622

(57) ABSTRACT

The present invention provides a food ingredient including elevated content of free amino acids such as glutamine, valine, isoleucine, leucine and arginine in whole meal of a seed of wheat or barley, ground products of a seed of wheat or barley during maturation period from immediately after the heading until the maturation, and the like, and its production method. More particularly, a food ingredient that is whole meal of a seed of wheat or barley, wherein the content of free glutamine is 200 to 1200 mg/100 g, the content of valine is 40 to 150 mg/100 g, the content of isoleucine is 30 to 120 mg/100g, the content of leucine is 40 to 150 mg/100 g and the content of arginine is 60 to 150 mg/100 g, and a method of the production of the food ingredient which includes allowing a seed of wheat or barley selected from a group of wheat, malting barley and naked barley to be impregnated in water at 20 to 30° C. for 24 to 72 hours, and the like are provided.

### TECHNICAL FIELD

The present invention relates to a food ingredient including enriched free amino acids and its production method, and particularly relates to a food ingredient having an elevated content of free glutamine, valine, isoleucine, leucine and arginine in a seed of wheat or barley and the like, and its production method. More particularly, the present invention relates to a food ingredient in which the content of the aforementioned 5 kinds of free amino acids is increased to a predetermined value; a method of the production of a food ingredient, the method comprising elevating the content of the free amino acids in a mature seed (including germinated seed) of wheat or barley by allowing a material seed of wheat or barley to be impregnated in water under a certain condition; and a method of the production of the aforementioned food ingredient by immersing at least one of whole meal, bran, shorts, red dog, or 60% flour of the material seed selected from a group of immature seeds of wheat or barley from immediately after the heading until the maturation, mature seeds, seeds prepared from mature seeds by allowing to be impregnated in water under a certain condition (including germinated seeds), in water under a certain condition.

### BACKGROUND ART

There are four methods of the production of an amino acid, i.e., fermentation methods, enzyme methods, synthesis methods and extraction method. Among these, the fermentation method and the enzyme method are principal methods, and 16 kinds of the amino acids among 20 kinds have been industrially produced by either of these two methods. Their applications are in a wide range of medical drugs as well as foods, cosmetics, feeds and the like.

Sodium glutamate is most frequently utilized among amino acids especially for flavoring. Next, quantities of consumed glycine, alanine are great which are an amino acid used for the purpose of improving the taste and keeping shelf life longer. In recent years, while investigations of physiological functions of amino acids have made advances, physiological roles of individual amino acids have been elucidated (see, “Amino Acid Handbook”, published by Institute for Industrial Research, p. 51-59, April 2003). As health consciousness of the consumers grows, beverages and supplements produced with focusing attention to health and nutrition functions of amino acids have been found in the market (see, “Syokuhin to Kaihatsu (Foods and Development)”, Vol. 34, No. 10, p. 4-8 and p. 20-22, 1999, published by Reserved CMP Japan Co., Ltd.). Above all, an advantage of ingestion of branched chain amino acids referred to as BCAAs such as valine, leucine and isoleucine, as well as glutamine and arginine has become common knowledge in fields of sports science (see, 57th Proceedings of Congress of Japanese Society of Nutrition and Food Science, p. 287).

Pharmacological actions of these amino acids are shown in Table 1. BCAAs account for 35% in muscular proteins and are consumed in muscle by exercise. Deficiency of BCAAs may result in muscular fatigue, muscular pain, and muscle strain. In order to solve these problems, it is effective to take BCAAs immediately before the exercise, or within 30 minutes immediately after the exercise, to thereby restore the muscle into the normal state. Hence, muscular pain and fatigue are rapidly cured, and muscle stronger than before damage can be constituted.

Amount of requirement of glutamine from intestinal tract and immunocytes is suddenly elevated upon stress during the exercise. Thus, glutamine concentration in skeletal muscle and liver may be reduced, leading to a variety of impairments such as compromised immunity, deterioration of restoring power, decrease in glycogen and break in balance of body's nitrogen balance.

Under such circumstances, supply of glutamine shall be required. Additionally, arginine exhibits a growth hormone secretagogue action, and an action to accelerate highly decomposing ammonia and to enhance cellular immunity. Growth hormone also relates to enhancement and restoration of muscle, and is believed to accelerate synthesis of muscular protein even more by supply of arginine.

On the other hand, there are no food containing free BCAAs, and glutamine and arginine in high concentrations in nature, and thus, there is no choice but to depend on supplements for the taking of them. However, production cost of BCAAs, and glutamine and arginine is comparatively extremely high among amino acids. Of these, the most inexpensive L-glutamic acid salt of arginine costs 7,000 yen per kg; valine costs 12,000 to 16,000 yen, and isoleucine costs approximately 18,000 yen. Furthermore, production of glutamine and leucine is restricted to use in medical drugs. In addition, predominant production method of leucine is currently the extraction method which requires high costs.

### DISCLOSURE OF THE INVENTION

The present invention provides, for solving the foregoing problems, a food ingredient having an elevated content of free amino acids such as BCAAs, glutamine and arginine in whole meal of the seed of wheat or barley, and in ground products of the seed of wheat or barley during maturation period from immediately after the heading until the maturation, and its production method.

The present inventors found that when the seed of wheat or barley is impregnated in water, germination is induced to allow the reserve proteins to be decomposed by endogenous protease to thereby increase the free amino acid content in the seed, and that when the ground product of the immature seed, mature seed, and seed subjected to an impregnation treatment in water is immersed in water under a certain condition, the protein is decomposed by the action of protease which is endogenously present in high concentration in bran primarily on the external side of the seed, and shorts including germ and thus, specific amino acids are released in high concentrations. According to such findings, the present invention was accomplished.

The invention according to claim 1 relates to a food ingredient that is whole meal of a seed of wheat or barley, wherein the content of free glutamine is 200 to 1200 mg/100 g, the content of valine is 40 to 150 mg/100 g, the content of isoleucine is 30 to 120 mg/100 g, the content of leucine is 40 to 150 mg/100 g and the content of arginine is 60 to 150 mg/100 g.

The invention according to claim 2 is a method of the production of the food ingredient according to claim 1 which comprises allowing a seed of wheat or barley selected from a group of wheat, malting barley and naked barley to be impregnated in water at 20 to 30° C. for 24 to 72 hours.

The invention according to claim 3 relates to a food ingredient that is a mixture of bran and shorts obtained by grinding a seed of wheat or barley during maturation period from immediately after the heading until the maturation, wherein the content of free glutamine is 150 to 405 mg/100 g, the content of valine is 190 to 325 mg/100 g, the content of isoleucine is 125 to 145 mg/100 g, the content of leucine is 350 to 520 mg/100 g and the content of arginine is 155 to 260 mg/100 g.

The invention according to claim 4 relates to a food ingredient that is a 60% flour obtained by grinding a seed of wheat or barley during maturation period from immediately after the heading until the maturation, wherein the content of free glutamine is 70 to 155 mg/100 g, the content of valine is 65 to 125 mg/100 g, the content of isoleucine is 30 to 60 mg/100 g, the content of leucine is 120 to 175 mg/100 g and the content of arginine is 105 to 305 mg/100 g.

The invention according to claim 5 relates to a food ingredient that is a mixture of bran and shorts obtained by grinding a seed of wheat or barley selected from a group of wheat, malting barley and naked barley, wherein the content of free glutamine is 20 to 430 mg/100 g, the content of valine is 20 to 435 mg/100 g, the content of isoleucine is 15 to 130 mg/100 g, the content of leucine is 35 to 435 mg/100 g and the content of arginine is 25 to 300 mg/100 g.

The invention according to claim 6 is a method of the production of the food ingredient according to any one of claims 3 to 5 which comprises allowing a ground product of a seed of wheat or barley selected from a group of wheat, malting barley and naked barley to be immersed in water under a condition of a pH of 3.0 to 5.5 and at 40 to 60° C. for 1 to 6 hours.

The invention according to claim 7 is the method of the production of the food ingredient according to claim 6 wherein the ground product of the seed of wheat or barley is at least one selected from a group of whole meal, bran, shorts, red dog, and 60% flour.

According to the invention, a food ingredient having the elevated free BCAAs, glutamine and arginine content can be produced by a simple operation from at least one of whole meal, bran, shorts, red dog, and 60% flour of a seed of wheat or barley selected from a group of wheat, malting barley and naked barley. It is believed that a novel demand can be raised by producing the food ingredient according to the invention, also for bran, shorts and red dog the use of which had been conventionally restricted to feeds and sources of cooking oil, and immature seeds and seeds subjected to an impregnation treatment in water (including germinated seeds) which had not been utilized in cooking ingredients, as well as sprouting seeds having a deteriorated commercial value.

The BCAAs, glutamine and arginine content are elevated in the food ingredient according to the invention, therefore, it is effective in enhancement of basic physical fitness, strengthening of muscle force, relief of fatigue and the like.

### BRIEF DESCRIPTION OF THE DRAWINGS

FIG. 1 is a view showing alteration of the glutamine content of whole meal obtained by subjecting a wheat seed to an impregnation treatment in water.

FIG. 2 is a view showing alteration of the valine content of whole meal obtained by subjecting a wheat seed to an impregnation treatment in water.

FIG. 3 is a view showing alteration of the isoleucine content of whole meal obtained by subjecting a wheat seed to an impregnation treatment in water.

FIG. 4 is a view showing alteration of the leucine content of whole meal obtained by subjecting a wheat seed to an impregnation treatment in water.

FIG. 5 is a view showing alteration of the arginine content of whole meal obtained by subjecting a wheat seed to an impregnation treatment in water.

FIG. 6 is a view showing an optimum pH of the amino acids produced by a water-immersion treatment of whole meal of a wheat seed.

FIG. 7 is a view showing an optimum pH of the amino acids produced by a water-immersion treatment of whole meal of a wheat seed.

FIG. 8 is a view showing an optimum temperature of the amino acids produced by a water-immersion treatment of whole meal of a wheat seed.

FIG. 9 is a view showing an optimum temperature of the amino acids produced by a water-immersion treatment of whole meal of a wheat seed.

### BEST MODE FOR CARRYING OUT THE INVENTION

Although cultivars and breeding lines of the wheat or barley which may be used in the present invention are not limited, cultivars including a large amount of production of the free amino acids (for example, in case of wheat, Esimasinriki, Asakazekomugi, Tikugoizumi and the like) as well as domestically popular cultivars the seeds of which are readily available (Norin. 61, Shirasagikomugi, Fukusayaka and the like) are preferably utilized.

In addition to wheat, malting barley, naked barley and the like can be similarly applied to the invention.

The invention according to claim 1 is a food ingredient that is whole meal of a seed of wheat or barley, wherein the content of free glutamine is 200 to 1200 mg/100 g, the content of valine is 40 to 150 mg/100 g, the content of isoleucine is 30 to 120 mg/100 g, the content of leucine is 40 to 150 mg/100 g and the content of arginine is 60 to 150 mg/100 g.

This food ingredient can be produced in accordance with the invention according to claim 2. More specifically, a seed of wheat or barley selected from a group of wheat, malting barley and naked barley is allowed to be impregnated in water at 20 to 30° C. for 24 to 72 hours.

According to this treatment, germination is induced, to thereby activate protease endogenously present in the germ. Thus, the protease acts on the reserve proteins included predominantly in germ, aleurone layer and the like to produce free amino acids. Thereafter, the seed of wheat or barley or the like including thus enriched free amino acids is dried at 40° C. or lower for 2 to 3 days, and the dried product is preferably stored while keeping the moisture content of 13% or less. Next, whole grains of the seed are ground to obtain the food ingredient.

Also, according to the invention, a so-called sprouting seed which had overtaken in the rainfall during maturation to lead to germinated state can be used as a raw material. In connection with the degree of maturation of the immature seed, more immature seeds exhibit more excellent ability of producing the amino acids, however, as they are more immature, treatments for threshing, drying and the like shall be complicated due to the higher moisture content and the smaller size. The seeds on 4 to 5 weeks after the heading have comparatively favorable in use/utilization, and the treatments for the harvesting and drying can be readily conducted.

The invention according to claim 3 is a food ingredient that is a mixture of bran and shorts obtained by grinding a seed of wheat or barley during maturation period from immediately after the heading until the maturation, wherein the content of free glutamine is 150 to 405 mg/100 g, the content of valine is 190 to 325 mg/100 g, the content of isoleucine is 125 to 145 mg/100 g, the content of leucine is 350 to 520 mg/100 g and the content of arginine is 155 to 260 mg/100 g.

Moreover, the invention according to claim 4 is a food ingredient that is a 60% flour obtained by grinding a seed of wheat or barley during maturation period from immediately after the heading until the maturation, wherein the content of free glutamine is 70 to 155 mg/100 g, the content of valine is 65 to 125 mg/100 g, the content of isoleucine is 30 to 60 mg/100 g, the content of leucine is 120 to 175 mg/100 g and the content of arginine is 105 to 305 mg/100 g.

The invention according to claim 5 is a food ingredient that is a mixture of bran and shorts obtained by grinding a seed of wheat or barley selected from a group of wheat, malting barley and naked barley, wherein the content of free glutamine is20 to 430 mg/100 g, the content of valine is20 to435 mg/100 g, the content of isoleucine is 15 to 130 mg/100 g, the content of leucine is 35 to 435 mg/100 g and the content of arginine is 25 to 300 mg/100 g.

These food ingredients can be produced in accordance with the invention according to claim 6. More specifically, in the method, a ground product of a seed of wheat or barley selected from a group of wheat, malting barley and naked barley (including seed of wheat or barley during maturation) is allowed to be immersed in water under a condition of a pH of 3.0 to 5.5 and at 40 to 60° C. for 1 to 6 hours. Separation of the wheat or barley such as wheat flour may be carried out by milling of the seed with a flour mill. (for example, manufactured by Buhler K. K., Buhler test mill or the like). Depending on gap size between the rolls and size of the sieve, the separation can be perfected into: bran including a seed coat as a principal component and having an aleurone layer; shorts including a germ as a principal component but also including the seed coat and the aleurone layer; red dog including the aleurone layer and albumen; and 60% flour including albumen as a principal component. The 60% flour is also referred to as first grade flour or special grade flour, indicating commercially available wheat flour.

A food ingredient in the form of an aqueous solution can be obtained from the ground product of seeds of wheat or barley including enriched free amino acids as described above by eliminating the insoluble matters. Additionally, a powdery food ingredient can be obtained by subjecting the same to a drying treatment at 110° C. or lower. When all the reaction products are utilized, a powdery food ingredient can be obtained similarly by subjecting to a drying treatment at 110° C. or lower. Furthermore, a food ingredient capable of being promptly processed can be obtained by adjusting the moisture content through separately adding milled flour to the reaction product as desired. Herein, the ground product of the seed of wheat or barley refers to any one of whole meal, bran, shorts, red dog, 60% flour, or a mixture of two or more thereof.

As described hereinabove, the method of the production of a food ingredient having an elevated amino acid content may be suitably selected depending on the shape of the target wheat or barley. As the first method, in case of the seed of wheat or barley selected from a group of wheat, malting barley and naked barley, the seed of wheat or barley is allowed to be impregnated in water at 20 to 30° C. for 24 to 72 hours. Further, in case of ground product of the seed of wheat or barley selected from a group of wheat, malting barley and naked barley, for example, when the ground product is at least one of whole meal, bran, shorts, red dog, and 60% flour, the reaction may be allowed by adding water having a pH adjusted to 3.0 to 5.5, and preferably 4.0 to 5.0 to the ground product in an amount of 5 to 40 times, followed by reciprocal shaking under a condition of at 40 to 60° C., usually at 45 to 55° C., at 50 to 150 rpm for 30 minutes or longer, usually for 1 to 6 hours, preferably at 45° C. and at 80 to 120 rpm for 1 to 6 hours.

The acid for use in adjusting the pH may be any one of organic acids and inorganic acids. Preferably, an organic acid such as acetic acid, citric acid or ascorbic acid, or an inorganic acid such as hydrochloric acid, sulfuric acid or phosphoric acid may be used. Also, examples of alkali which may be used include sodium phosphate, potassium phosphate, sodium carbonate, sodium hydroxide and the like.

The food ingredient of the invention enriched with free amino acids including the ground product of the seed of wheat or barley can contribute to enhancement of basic physical fitness, strengthening of muscle force, relief of fatigue and the like by routinely taking the food ingredient. In this instance, when it is taken, for example, immediately after the exercise, it is desired that the composition ratio of each amino acid of valine, isoleucine, leucine, arginine and glutamine is regulated to be 1:1:1-2:1 or greater:l or greater.

Moreover, although the intake needed a dosage may be dependent on physical activity, generally, rough standard may be approximately 500 to 2000 mg in total amount of BCAAs. Any disturbance on human body due to the excessive amount of intake has not been reported. When the glutamine content is too high among the contents of other free amino acids, for example, as shown in Table 3 shown later, the amount can be reduced ad libitum by controlling the water-immersion time.

Next, the present invention will be explained in more detail by way of Examples, however, the invention is not limited thereto.

### EXAMPLE 1

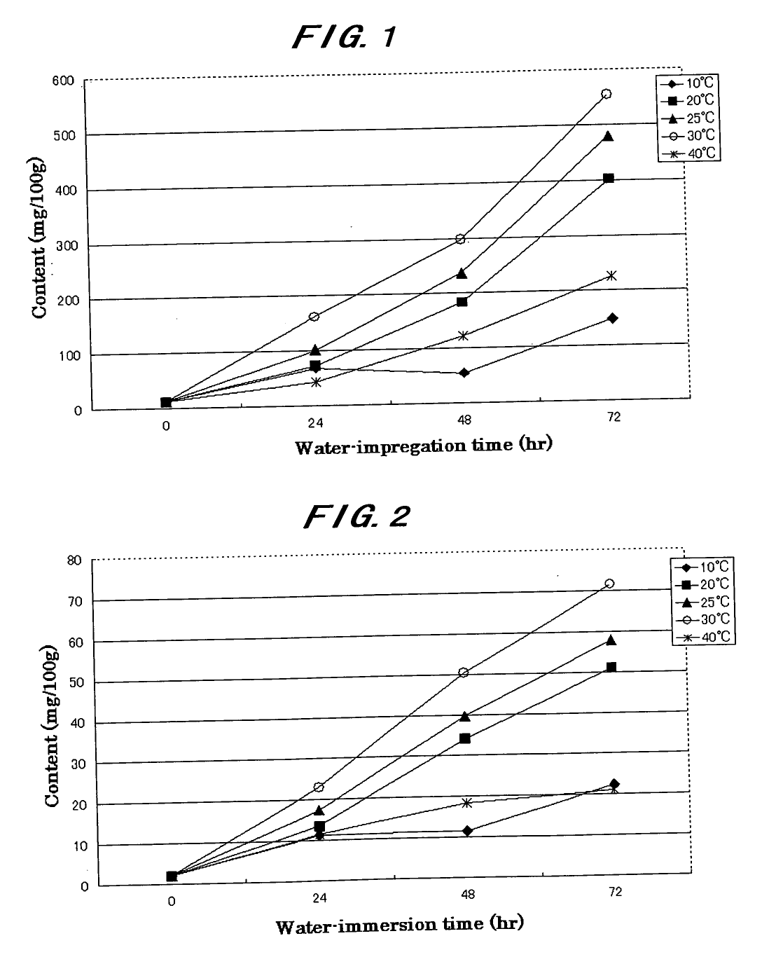

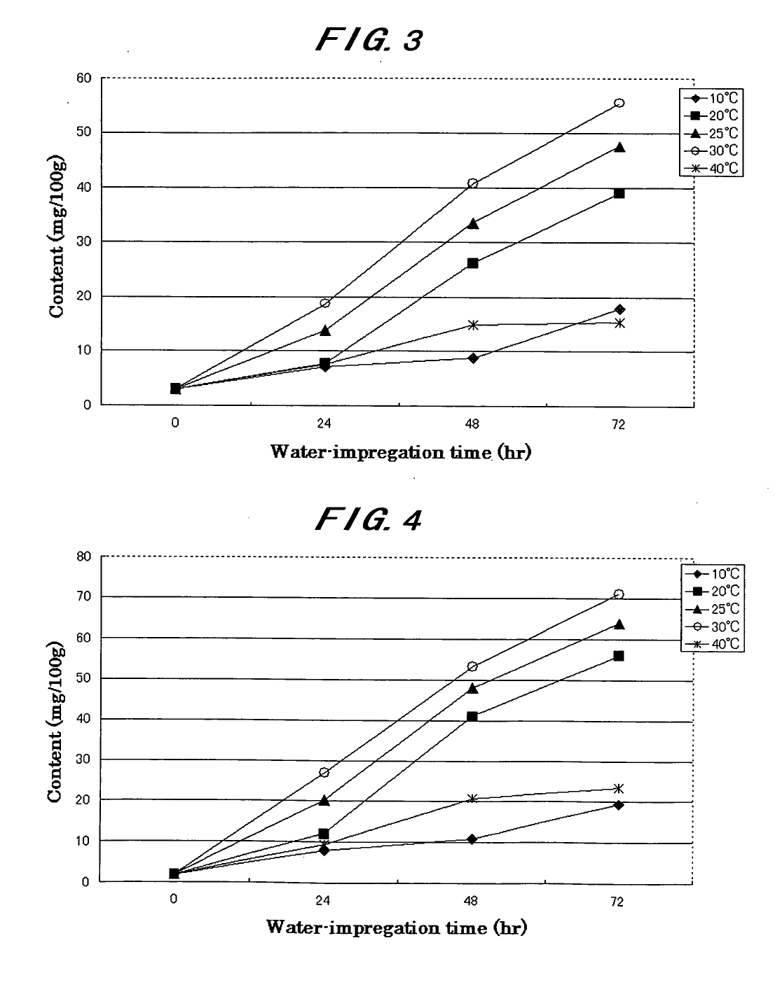

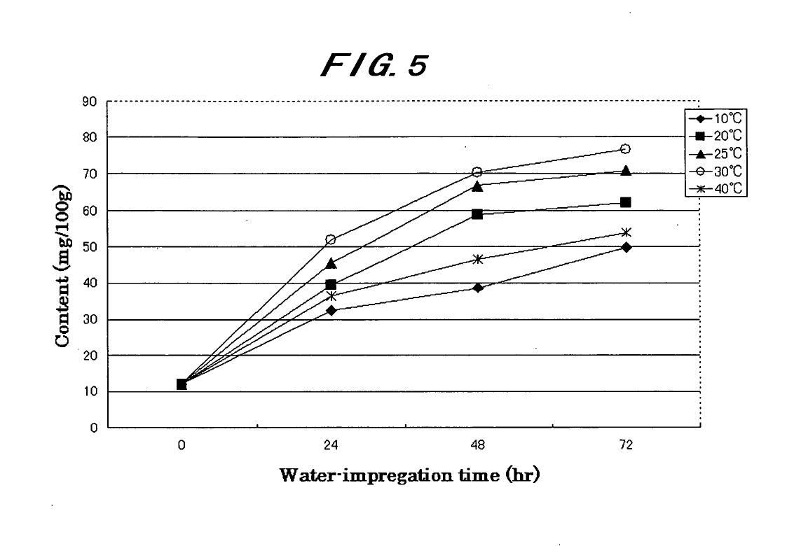

After a mature seed of wheat (Fukusayaka) was subjected to an impregnation treatment in water at a temperature of 10 to 40° C. for 0 to 72 hours, it was dried at 35° C. for 3 days, which was then ground with a Cyclotec(R) Sample Mill (manufactured by Cyclotec) to obtain whole meal. Time dependent change of free glutamine, valine, isoleucine, leucine, arginine content in the whole meal was determined with a Hitachi L-8500 amino acid analyzer. The results are shown in FIG. 1 to FIG. 5.

As for glutamine, the content of which increased the greatest extent by the impregnation treatment in water, when the impregnation treatment was carried out at 30° C., its content increased to about 165 mg/100 g after 24 hours, and reached to about 550 mg/100 g after 72 hours. As is clear from the figure, the amount of increase in glutamine was large in the order of at 30° C., 25° C., 40° C. and 10° C.

On the other hand, valine increased to a great extent in three experimental plots of 30° C., 25° C. and 20° C., the content of which reaches to about 72 mg/100 g, 58 mg/100 g and 51 mg/100 g, respectively, after 72 hours. Amount of accumulation of isoleucine and leucine tended to be similar to that of valine, and the amount of increase was large in the order of at 30° C., 25° C. and 20° C. The isoleucine content 72 hours later was 56 mg/100 g, 48 mg/100 g and 39 mg/100 g at 30° C., 25° C. and 20° C., respectively, while the leucine content was 71 mg/100 g, 63 mg/100 g and 57 mg/100 g at 30° C., 25° C. and 20° C., respectively. Additionally, the accumulation of arginine did not vary as in the case of other amino acids, however, the amount of increase was, similar to other cases, the highest at 30° C., and then followed in the order of at 25° C., 20° C., 40° C. and 10° C. Therefore, optimal temperature for the water-impregnation treatment is 25 to 30° C. on any one of the amino acids.

With reference to relationship between germination and the accumulation of the amino acids, according to the results of carrying out the germination test, the germination percentage after one day was, in decreasing order, 25° C. (87%), 20° C. (79%), 30° C. (69%), 10° C. (0%). No germination was found at 40° C. even after 3 days. As a result, the optimum temperature of the germination was 20 to 25° C., which did not coincide with the optimum temperature of the accumulation of the amino acids.

### EXAMPLE 2

To 0.2 g of bran, shorts, red dog, and 60% flour prepared from a mature seed of wheat (Fukusayaka) was added 4 ml of 50 mM potassium phosphate buffer (pH 4.5). The mixture was shaken at 45° C. and at 100 rpm. Thus, free glutamine, valine, isoleucine, leucine and arginine can be produced. Table 1 shows the amount of amino acids produced by the reaction for 2 hours. The value in parentheses indicates the initial content. Total amount following the reaction is a sum of the amount of production by the reaction and the initial content.

TABLE 1
Amount of production (mg/100 g)

| | Bran | Shorts | Red dog | 60% flour |
|---|---|---|---|---|
| Glutamine | 59.26 | 45.82 | 0.29 | 0.72 |
| | (0.00) | (0.00) | (0.00) | (0.00) |
| Valine | 46.45 | 73.05 | 9.39 | 0.58 |
| | (5.67) | (6.33) | (1.69) | (1.40) |
| Isoleucine | 24.10 | 39.02 | 5.03 | 2.31 |
| | (4.11) | (4.68) | (2.02) | (1.95) |
| Leucine | 87.43 | 127.5 | 22.93 | 3.92 |
| | (5.25) | (5.66) | (2.58) | (1.15) |
| Arginine | 54.91 | 78.07 | 10.63 | 11.34 |
| | (26.98) | (49.45) | (8.77) | (4.39) |

As is clear from Table, the amount of production of glutamine was the largest in bran, while the amount of production of the amino acids other than that was the largest in shorts. The amount of production in shorts was large in the order of leucine, arginine, valine, glutamine and isoleucine, while that in bran followed the order of leucine, glutamine, arginine, valine and isoleucine. In red dog and 60% flour, the amount of production was less than that in the bran and shorts. It was characterized in that the production of glutamine is low, while production of leucine and arginine is comparatively high.

### EXAMPLE 3

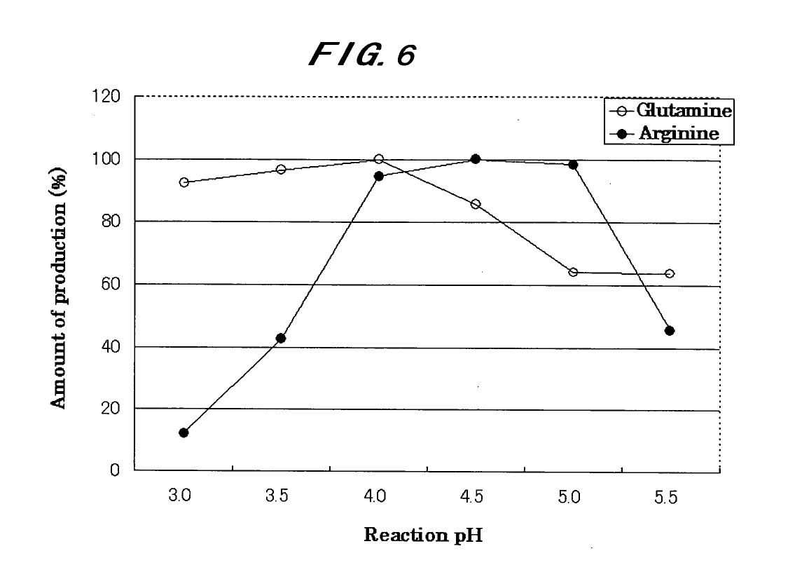

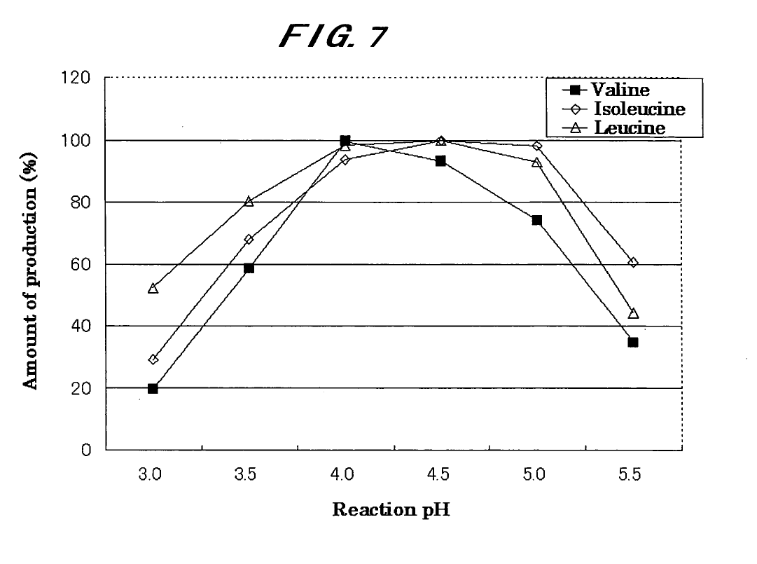

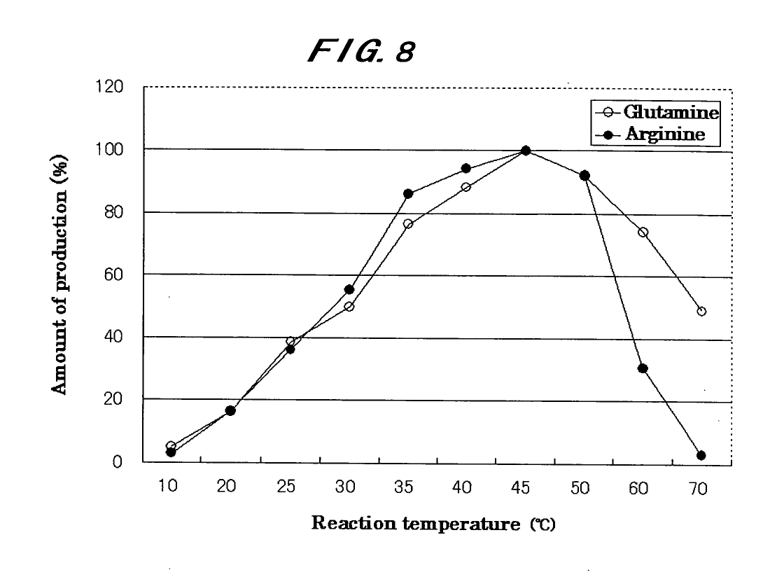

According to Example 2, using the whole meal of Fukusayaka, a treatment was carried out under a condition of at 40° C., a pH of 3.0 to 5.5 for 1 hour, and the amount of production of each amino acid was measured. Consequently, as shown in FIG. 6 and FIG. 7, the production of glutamine and valine was optimum at a pH of 4.0, while the production of isoleucine, leucine and arginine was optimum at a pH of 4.5.

### EXAMPLE 4

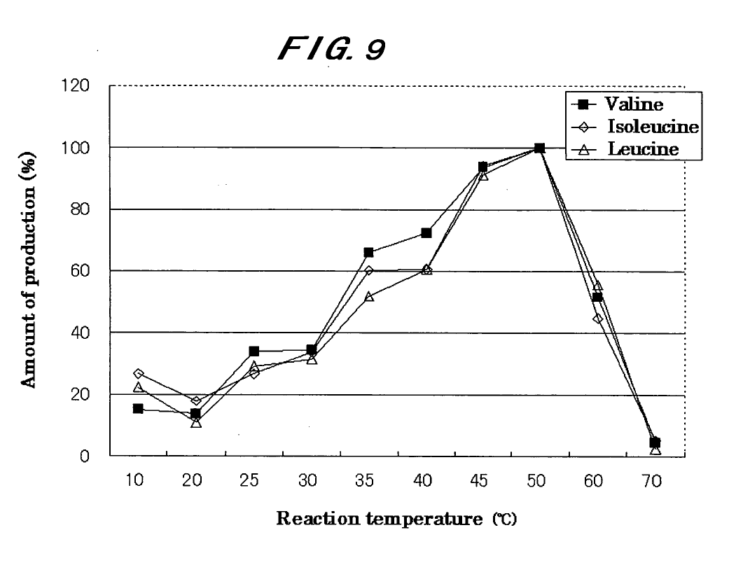

According to Example 2, using the whole meal of Fukusayaka, an immersion treatment in water was carried out under a condition of at 10 to 70° C., a pH of 4.5 for 1 hour, and the amount of production of each amino acid was measured. Consequently, as shown in FIG. 8 and FIG. 9, the production of glutamine and arginine was optimum at 45° C., while the production of valine, isoleucine and leucine was optimum at 50° C. When the temperature was 25° C. or lower and 60° C. or higher, the amount of production was drastically decreased.

### EXAMPLE 5

An immature seed of Tikugoizumi 4 week after the heading was freeze-dried, and to 0.1 g of the mixture of bran and shorts and 60% flour of the dry seed was added 4 ml of 50 m potassium phosphate buffer (pH 4.5). The mixture was shaken at 45° C. and at 100 rpm. Thereafter, the amount of thus produced free amino acid was measured. The results are shown in Table 2.

TABLE 2
Amount of production (mg/100 g)

| | The mixture of bran and shorts | | | | 60% Flour | | | |
|---|---|---|---|---|---|---|---|---|
| | initial | | | | initial | | | |
| | value | 1 hour | 4 hrs | 6 hrs | value | 1 hour | 4 hrs | 6 hrs |
| Glutamine | 160.72 | 123.5 | 243.2 | 98.46 | 66.08 | 70.08 | 97.43 | 47.07 |
| Valine | 110.84 | 121.7 | 242.7 | 222.47 | 80.20 | 38.18 | 100.2 | 62.76 |
| Isoleucine | 56.64 | 53.49 | 126.3 | 87.71 | 40.32 | 16.30 | 46.12 | 33.81 |
| Leucine | 84.20 | 192.0 | 450.9 | 445.78 | 58.24 | 52.67 | 156.2 | 131.77 |
| Arginine | 53.96 | 111.7 | 245.0 | 234.64 | 28.36 | 25.50 | 78.32 | 54.43 |

As shown in Table 2, initial content of each amino acid was high in the ground product of the immature seed, and the amount of production of each amino acid by the reaction was also extremely large. In the mixture of bran and shorts, all amino acids other than isoleucine were produced in an amount of 100 mg/100 g or more by the reaction for 1 hour, while all amino acids other than isoleucine were produced in an amount of 200 mg/100 g or more by the reaction for 4 hours. The amount of production in the 60% flour was low in comparison with the mixture of bran and shorts, however, it had an ability of the production which was nearly equal to that of the shorts of the mature seed. To the contrary, when the reaction was over 4 hours, the amount of the amino acid obtained after the reaction began to decrease in both of the mixture of bran and shorts and 60% flour, and after 8 hours, the amount became nearly equal to the initial value.

Therefore, when the immature seed was allowed to react, the reaction for 1 to 4 hours was preferred. When the composition of the amino acids produced in the bran of the immature seed was compared with that produced in the shorts of the mature seed, the ratio of glutamine was high while the ratio of isoleucine was low in the immature seed.

### EXAMPLE 6

According to Example 1, the mature seed of Fukusayaka was subjected to an impregnation treatment in water at 20° C. for 0 to 72 hours, and dried at 35° C. for 3 days. With regard to the whole meal obtained by grinding the mature seed, relationship between each impregnation treatment time and the amino acids produced in case of carrying out the water-immersion reaction at 45° C. and a pH of 4.5 for 1 hour (amount of variation with respect to the initial content) is shown in Table 3. The values in Table are presented by a unit of mg/100 g. The value in parentheses indicates the initial content.

TABLE 3
Impregnation treatment time (hr)

| | 0 | 12 | 24 | 36 | 48 | 72 |
|---|---|---|---|---|---|---|
| Glutamine | 1.72 | −2.32 | −11.18 | −27.90 | −51.31 | −112.1 |
| | (5.31) | (35.64) | (78.18) | (126.34) | (194.62) | (396.82) |
| Valine | 10.05 | 10.56 | 13.29 | 23.08 | 23.73 | 25.55 |
| | (2.99) | (8.61) | (13.62) | (23.61) | (34.28) | (52.82) |
| Isoleucine | 4.51 | 6.30 | 7.43 | 12.69 | 13.47 | 16.65 |
| | (2.21) | (5.89) | (11.69) | (16.36) | (26.72) | (38.77) |
| Leucine | 17.46 | 21.54 | 25.30 | 43.57 | 46.55 | 59.28 |
| | (3.01) | (6.35) | (12.63) | (26.73) | (44.31) | (55.55) |
| Arginine | 8.14 | 4.38 | 15.02 | 14.52 | 15.47 | 22.20 |
| | (16.66) | (26.53) | (42.18) | (48.96) | (59.43) | (60.42) |

As is clear from Table 3, the sample of the water-impregnation treatment for 12 hours was not altered so much as compared to the untreated sample, however, when the treatment was carried out over 24 hours, decrease in glutamine content became prominent, and in addition, increase in leucine, valine, arginine and isoleucine contents became marked. The concentration of glutamine was increased to about 400 mg/100 g in 72 hours by the water-impregnation treatment (FIG. 1). Accordingly, the water-impregnation treatment of the seed followed by the water-immersion treatment of the ground flour enabled control of the content ratio of glutamine to other amino acids (valine, isoleucine, leucine and arginine).

### EXAMPLE 7

According to Example 2, each amino acid was produced by a reaction at 45° C. and a pH of 4.5 for 1 hour using whole meal of the seed of each cultivars and breeding lines of wheat. Measurement results of the amount of production of each amino acid are shown in Table 4. The values are presented by a unit of mg/100 g. The value in parentheses indicates the initial content. Total amount after the reaction is a sum of the amount of production by the reaction and the initial content.

TABLE 4

| | Glutamine | Valine | Isoleucine | Leucine | Arginine |
|---|---|---|---|---|---|
| Norin 61 | 5.88 | 5.86 | 7.25 | 16.85 | 11.31 |
| | (0.00) | (1.67) | (1.49) | (2.15) | (6.69) |
| Shirasagikomugi | 5.98 | 8.30 | 6.88 | 21.50 | 12.88 |
| | (0.00) | (1.81) | (1.40) | (1.82) | (7.20) |
| Chugoku 143 | 6.35 | 6.19 | 5.69 | 18.24 | 12.25 |
| | (0.00) | (2.09) | (1.75) | (2.60) | (9.26) |
| Fukusayaka | 7.98 | 8.08 | 3.79 | 22.11 | 12.02 |
| | (0.00) | (2.57) | (2.76) | (2.23) | (14.92) |
| Chugoku 147 | 6.86 | 6.84 | 6.42 | 19.38 | 11.29 |
| | (0.00) | (2.13) | (1.61) | (2.41) | (7.00) |
| Chugoku 149 | 6.66 | 7.72 | 5.72 | 20.28 | 17.39 |
| | (0.00) | (1.96) | (1.50) | (1.82) | (9.26) |
| Chugoku 152 | 7.54 | 8.12 | 7.49 | 23.01 | 18.12 |
| | (0.00) | (1.77) | (1.45) | (1.97) | (8.33) |
| Chugoku 140 | 7.59 | 12.74 | 7.60 | 24.60 | 22.60 |
| | (0.00) | (0.91) | (1.58) | (2.07) | (6.91) |
| Norin 17 | 5.93 | 10.96 | 7.31 | 20.93 | 18.19 |
| | (0.00) | (0.85) | (1.77) | (2.52) | (7.41) |
| Produra | 26.37 | 13.29 | 7.57 | 20.32 | 18.98 |
| | (0.00) | (1.15) | (2.45) | (3.26) | (17.29) |
| Esimasinriki | 14.19 | 21.00 | 7.31 | 30.60 | 21.95 |
| | (0.00) | (1.49) | (2.63) | (3.50) | (7.20) |
| Shinchunaga | 11.57 | 16.53 | 8.18 | 26.48 | 19.35 |
| | (0.00) | (1.40) | (2.22) | (3.19) | (17.50) |
| Saikai 180 | 10.48 | 12.34 | 5.66 | 18.77 | 13.41 |
| | (0.00) | (1.11) | (1.91) | (2.90) | (21.72) |
| Haruyutaka | 5.42 | 10.81 | 5.87 | 16.08 | 15.40 |
| | (0.00) | (0.71) | (1.72) | (2.84) | (9.16) |
| Coco | 6.31 | 13.21 | 6.33 | 22.03 | 19.88 |
| | (0.00) | (0.93) | (1.63) | (2.13) | (9.94) |
| Roblin | 10.11 | 14.38 | 7.37 | 22.52 | 24.02 |
| | (0.00) | (0.89) | (1.42) | (1.69) | (10.29) |
| Kanto 107 | 8.14 | 15.83 | 8.09 | 23.46 | 24.34 |
| | (0.00) | (0.74) | (1.45) | (2.02) | (7.31) |
| Tikugoizumi | 12.27 | 16.13 | 7.80 | 24.77 | 24.49 |
| | (0.00) | (1.01) | (1.72) | (2.67) | (8.34) |
| Jessore | 10.93 | 17.25 | 8.06 | 25.13 | 26.06 |
| | (0.00) | (1.30) | (1.75) | (2.50) | (7.51) |
| Nanbukomugi | 6.25 | 13.07 | 6.91 | 19.83 | 15.15 |
| | (0.00) | (1.08) | (1.59) | (2.12) | (15.64) |
| Toyohokomugi | 8.55 | 10.05 | 5.95 | 16.24 | 21.95 |
| | (0.00) | (0.63) | (1.42) | (2.14) | (5.30) |
| Asakazekomugi | 12.41 | 18.13 | 8.55 | 30.19 | 26.36 |
| | (0.00) | (0.85) | (1.60) | (1.98) | (8.13) |
| Minaminokomugi | 9.67 | 18.05 | 7.98 | 29.70 | 29.58 |
| | (0.00) | (0.83) | (1.43) | (2.03) | (11.32) |
| Fukuhokomugi | 11.00 | 15.91 | 7.89 | 27.58 | 24.19 |
| | (0.00) | (0.90) | (1.41) | (1.85) | (11.33) |
| 1CW | 10.12 | 15.98 | 6.16 | 25.95 | 23.94 |
| | (0.00) | (2.34) | (2.67) | (3.42) | (14.41) |
| PH | 21.69 | 14.92 | 4.83 | 19.50 | 28.85 |
| | (0.00) | (2.46) | (3.36) | (3.28) | (17.60) |
| ASW | 6.05 | 11.90 | 7.02 | 20.32 | 13.00 |
| | (0.00) | (1.66) | (2.23) | (2.93) | (5.15) |
| WW | 9.37 | 12.63 | 4.42 | 17.46 | 16.66 |
| | (0.00) | (2.23) | (2.63) | (3.26) | (9.78) |

As shown in Table 4, each amino acid was produced in all cultivars and breeding lines. Amount of production was large for glutamine in the order of Produra, PH, Esimasinriki, Asakazekomugi and Tikugoizumi; for valine in the order of Esimasinriki, Asakazekomugi, Minaminokomugi, Jessore and Shinchunaga; for isoleucine in the order of Asakazekomugi, Shinchunaga, Kanto 107, Jessore and Minaminokomugi; for leucine in the order of Esimasinriki, Asakazekomugi, Minaminokomugi, Fukuhokomugi and Shinchunaga; for arginine in the order of Minaminokomugi, PH, Asakazekomugi, Jessore and Tikugoizumi.

In any of the cultivars, the amount of production of each amino acid increased in a time dependent manner. For example, in case of Fukusayaka, the reaction for 6 hours yielded glutamine, valine, isoleucine, leucine and arginine of. 16.26, 17.93, 11.94, 27.70 and 24.17 mg per 100 g, respectively. As the reaction time was prolonged, the amount of production was further increased.

### EXAMPLE 8

According to Example 2, each amino acid was produced by a reaction under a condition of a pH of 4.5 and at 45° C. for 1 hour using whole meal of the seed of each cultivar of the barleys. Results are shown in Table 5. The values are presented by a unit of mg/100 g. The value in parentheses indicates the initial content. Total amount after the reaction is a sum of the amount of production by the reaction and the initial content.

TABLE 5

| | Glutamine | Valine | Isoleucine | Leucine | Arginine |
|---|---|---|---|---|---|
| Naked barley | | | | | |
| Mantenboshi | 3.23 | 13.03 | 5.87 | 20.07 | 12.90 |
| | (0.00) | (8.02) | (4.48) | (4.08) | (7.40) |
| Ichibanboshi | 1.27 | 12.08 | 7.86 | 25.99 | 17.39 |
| | (0.00) | (4.64) | (2.67) | (2.32) | (3.42) |
| Daishimochi | 2.38 | 12.12 | 9.39 | 28.44 | 15.88 |
| | (0.00) | (3.52) | (1.62) | (0.99) | (4.32) |
| Malting barley | | | | | |
| Nishinochikara | 18.32 | 11.10 | 5.05 | 21.34 | 14.11 |
| | (38.34) | (4.78) | (3.53) | (4.23) | (4.76) |
| Amagi Nijo | 16.93 | 13.58 | 10.17 | 32.64 | 16.56 |
| | (14.15) | (4.59) | (1.87) | (2.03) | (4.79) |
| Skygolden | 14.34 | 11.03 | 3.96 | 18.81 | 15.17 |
| | (20.71) | (4.70) | (3.92) | (4.87) | (4.68) |

As shown in Table 5, similar to wheat, free amino acids were produced by allowing the milled flour to be immersed in water. In the naked barley, the amount of production was large for amino acids in the order of leucine, arginine, valine, isoleucine and glutamine. To the contrary, in malting barley, the amount followed the order of leucine, glutamine, arginine, valine and isoleucine.

### EXAMPLE 9

The seed of malting barley was subjected to an impregnation treatment in water at 15° C. for 24 hours. Amino acid contents of whole meal of the seed dried at 40° C. for 3 days, and of the reaction product obtained by allowing thus obtained whole meal to react in water at 40° C. for 1 hour were measured. Results are shown in Table 6. The values in Table are presented by a unit of mg/100 g.

TABLE 6

| | Glutamine | Valine | Isoleucine | Leucine | Arginine |
|---|---|---|---|---|---|
| Nishinochikara | | | | | |
| Initial value of whole | 38.34 | 4.78 | 3.53 | 4.23 | 4.76 |
| meal | | | | | |
| Whole meal after | 998.1 | 52.23 | 43.64 | 67.04 | 64.47 |
| water-impregnation | | | | | |
| treatment | | | | | |
| Whole meal after | 1200 | 110.3 | 70.72 | 163.5 | 110.2 |
| water-immersion | | | | | |
| treatment | | | | | |
| Amagi Nijo | | | | | |
| Initial value of whole | 14.15 | 4.59 | 1.87 | 2.03 | 4.79 |
| meal | | | | | |
| Whole meal after | 1010 | 55.47 | 38.19 | 59.73 | 76.26 |
| water-impregnation | | | | | |
| treatment | | | | | |
| Whole meal after | 1290 | 134.9 | 75.07 | 194.3 | 146.0 |
| water-immersion | | | | | |
| treatment | | | | | |

As is clear from Table, the amino acid content in the seed was greatly increased by subjecting the seed to the impregnation treatment in water, similar to wheat. Moreover, when the milled flour of the seed was allowed to react at 40° C. for 1 hour, amino acids were newly produced. When the amount of production of the amino acid was compared with that of wheat, ratio of glutamine was high among the amino acids that were increased according to the water-impregnation treatment. Furthermore, the glutamine content was decreased by the water-immersion reaction of the ground flour in case of wheat as described above, however, such content was increased in barleys, on the contrary.

### EXAMPLE 10

Bran and shorts prepared from the seed of each cultivars and breeding lines of wheat were allowed to react at a pH of 4.5 and at 45° C. for 1 to 6 hours according to Example 2. The amount of production of the amino acids then is shown in Table 7.

TABLE 7

| | | | | |
|---|---|---|---|---|
| Glutamine | Valine | Isoleucine | Leucine | Arginine |

Initial value

| | | | | | |
|---|---|---|---|---|---|
| Bran | | | | | |
| Norin 61 | 0.00 | 3.68 | 2.22 | 5.03 | 12.10 |
| Fukusayaka | 0.00 | 5.67 | 4.11 | 5.25 | 26.98 |
| Produra | 0.00 | 2.54 | 3.65 | 7.67 | 31.27 |
| Esimasinriki | 0.00 | 3.29 | 3.91 | 8.24 | 13.02 |
| Asakazekomugi | 0.00 | 1.88 | 2.38 | 4.66 | 14.70 |
| Minaminokomugi | 0.00 | 1.83 | 2.13 | 4.78 | 20.48 |
| Shorts | | | | | |
| Norin 61 | 0.00 | 4.11 | 2.53 | 5.46 | 22.17 |
| Fukusayaka | 0.00 | 6.33 | 4.68 | 5.66 | 49.45 |
| Produra | 0.00 | 2.83 | 4.15 | 8.27 | 57.30 |
| Esimasinriki | 0.00 | 3.67 | 4.46 | 8.98 | 23.86 |
| Asakazekomugi | 0.00 | 2.09 | 2.71 | 5.03 | 26.95 |
| Minaminokomugi | 0.00 | 2.04 | 2.42 | 5.15 | 37.52 |

Amount of production by 1-hour reaction

| | | | | | |
|---|---|---|---|---|---|
| Bran | | | | | |
| Norin 61 | 24.45 | 19.54 | 28.12 | 36.65 | 27.38 |
| Fukusayaka | 33.19 | 26.94 | 14.72 | 48.09 | 29.10 |
| Produra | 109.66 | 44.31 | 29.35 | 44.19 | 45.95 |
| Esimasinriki | 59.01 | 70.02 | 28.35 | 66.15 | 53.14 |
| Asakazekomugi | 51.61 | 60.45 | 33.16 | 65.66 | 63.82 |
| Minaminokomugi | 40.21 | 60.18 | 30.95 | 64.59 | 71.61 |
| Shorts | | | | | |
| Norin 61 | 18.57 | 29.67 | 44.04 | 52.49 | 38.20 |
| Fukusayaka | 25.20 | 40.91 | 23.02 | 68.85 | 40.60 |
| Produra | 83.28 | 67.29 | 45.98 | 63.28 | 64.10 |
| Esimasinriki | 44.81 | 106.32 | 44.40 | 95.29 | 74.13 |
| Asakazekomugi | 39.19 | 91.79 | 51.94 | 94.01 | 89.03 |
| Minaminokomugi | 30.54 | 91.38 | 48.47 | 92.49 | 99.48 |

Amount of production by 6-hours reaction

| | | | | | |
|---|---|---|---|---|---|
| Bran | | | | | |
| Norin 61 | 171.28 | 116.26 | 41.38 | 228.48 | 113.59 |
| Fukusayaka | 123.85 | 104.05 | 61.70 | 181.65 | 108.72 |
| Produra | 430.89 | 191.20 | 81.23 | 223.97 | 148.13 |
| Esimasinriki | 298.86 | 289.37 | 73.02 | 295.10 | 168.09 |
| Asakazekomugi | 271.42 | 260.84 | 72.76 | 298.09 | 193.27 |
| Minaminokomugi | 211.50 | 265.22 | 72.33 | 286.42 | 212.05 |
| Shorts | | | | | |
| Norin 61 | 131.17 | 174.68 | 66.19 | 331.57 | 160.69 |
| Fukusayaka | 94.85 | 156.33 | 97.72 | 263.93 | 153.80 |
| Produra | 329.98 | 287.28 | 129.98 | 325.04 | 209.97 |
| Esimasinriki | 228.87 | 434.76 | 116.84 | 428.28 | 237.78 |
| Asakazekomugi | 207.84 | 391.90 | 116.42 | 432.68 | 273.89 |
| Minaminokomugi | 161.94 | 398.48 | 115.74 | 415.88 | 299.97 |

### INDUSTRIAL APPLICABILITY

The food ingredient according to the invention is a seed of wheat or barley including enriched free BCAAs, glutamine and arginine, and the milled flour thereof, which can be similarly utilized to conventional wheat flour and wheat processed products. For example, it can be utilized in materials of noodles such as Japanese wheat noodles (udon) and silver line noodles (somen), breads, snacks, flour paste products such as rice cake and dumpling cake made of rice or wheat flour. In case of use in the bread, savor can be improved by adding raisin, walnut, sesame, herb or the like to the material. Moreover, amino acids are dissolved in the water soluble fraction of the milled flour to which an appropriate amount of water was added, and the reaction product obtained by allowing the milled flour to be immersed in water to react, therefore, they can be utilized also in beverages and the like by: a method in which precipitates and insoluble matters are removed, followed by subjecting to a processing such as seasoning and sterilization; a method in which the ground product, particularly green powder harvested earlier is placed in a tea bag, and brewed alone or together with a tea leaf; or the like. In addition, when the liquid matter is subjected to a drying treatment, it can be also used in the form of flour, tablet or the like, as a supplement that is effective in muscular pain, chronic fatigue, and relief of fatigue after exercise.

1. A food ingredient that is a mixture of bran and shorts obtained by grinding a seed of wheat or barley during maturation period from immediately after the heading until the maturation, wherein the content of free glutamine is 150 to 405 mg/100 g, the content of valine is 190 to 325 mg/100 g, the content of isoleucine is 125 to 145 mg/100 g, the content of leucine is 350. to 520 mg/100 g and the content of arginine is 155 to 260 mg/100 g.

2. A food ingredient that is a 60% flour obtained by grinding a seed of wheat or barley during maturation period from immediately after the heading until the maturation, wherein the content of free glutamine is 70 to 155 mg/100 g, the content of valine is 65 to 125 mg/100 g, the content of isoleucine is 30 to 60 mg/100 g, the content of leucine is 120 to 175 mg/100 g and the content of arginine is 105 to 305 mg/100 g.

3. A food ingredient that is a mixture of bran and shorts obtained by grinding a seed of wheat or barley selected from a group of wheat, malting barley and naked barley, wherein the content of free glutamine is 20 to 430 mg/100 g, the content of valine is 20 to 435 mg/100 g, the content of isoleucine is 15 to 130 mg/100 g, the content of leucine is 35 to 435 mg/100 g and the content of arginine is 25 to 300 mg/100 g.

4. A method of the production of the food ingredient according to any one of claims 3 to 5 which comprises allowing a ground product of a seed of wheat or barley selected from a group of wheat, malting barley and naked barley to be immersed in water under a condition of a pH of 3.0 to 5.5 and at 40 to 60° C. for 1 to 6 hours.

5. The method of the production of the food ingredient according to claim 6 wherein the ground product of the seed of wheat or barley is at least one selected from a group of whole meal, bran, shorts, red dog, and 60% flour.

6.

7.
